(19) United States
(12) Patent Application Publication
(10) Pub. No.: US 2009/0062943 A1
(43) Pub. Date: Mar. 5, 2009

(54) Methods and apparatus for automatically controlling the sound level based on the content

(75) Inventors: Benbuck Nason, Castro Valley, CA (US); Ivy Tsai, San Jose, CA (US); David Goodenough, Hayward, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Sony Computer Entertainment Inc.

(21) Appl. No.: 11/895,723

(22) Filed: Aug. 27, 2007

(51) Int. Cl. G06F 17/00

(52) U.S. Cl. 700/94

(57) ABSTRACT

In one embodiment, the methods and apparatuses detect content and information related to the content; utilize the content at a current sound level; and modify the current sound level based on the information and the content.

### FIELD OF THE INVENTION

The present invention relates generally to controlling the sound level and, more particularly, to automatically controlling the sound level based on the content.

### BACKGROUND

In conjunction with content, there are many devices that are capable of reproducing audio signals for a user. In some instances, the audio signals are reproduced at sound levels that are either too low or too high for the user. For example, the audio signals associated with a television commercial may be reproduced too loudly at times for the user. Similarly, the audio signals associated with a television program maybe reproduced too softly for the user.

### SUMMARY

In one embodiment, the methods and apparatuses detect content and information related to the content; utilize the content at a current sound level; and modify the current sound level based on the information and the content.

### BRIEF DESCRIPTION OF THE DRAWINGS

The accompanying drawings, which are incorporated in and constitute a part of this specification, illustrate and explain one embodiment of the methods and apparatuses for automatically controlling the sound level based on the content. In the drawings,

FIG. 1 is a diagram illustrating an environment within which the methods and apparatuses for automatically controlling the sound level based on the content are implemented;

FIG. 2 is a simplified block diagram illustrating one embodiment in which the methods and apparatuses for automatically controlling the sound level based on the content are implemented;

FIG. 3 is a simplified block diagram illustrating a system, consistent with one embodiment of the methods and apparatuses for automatically controlling the sound level based on the content;

FIG. 4 illustrates an exemplary record consistent with one embodiment of the methods and apparatuses for automatically controlling the sound level based on the content;

FIG. 5 is a flow diagram consistent with one embodiment of the methods and apparatuses for automatically controlling the sound level based on the content; and

FIG. 6 is a flow diagram consistent with one embodiment of the methods and apparatuses for automatically controlling the sound level based on the content.

### DETAILED DESCRIPTION

The following detailed description of the methods and apparatuses for automatically controlling the sound level based on the content refers to the accompanying drawings. The detailed description is not intended to limit the methods and apparatuses for automatically controlling the sound level based on the content. Instead, the scope of the methods and apparatuses for automatically selecting a profile is defined by the appended claims and equivalents. Those skilled in the art will recognize that many other implementations are possible, consistent with the methods and apparatuses for automatically controlling the sound level based on the content.

References to “electronic device” includes a device such as a personal digital video recorder, digital audio player, gaming console, a set top box, a personal computer, a cellular telephone, a personal digital assistant, a specialized computer such as an electronic interface with an automobile, and the like.

References to “content” includes audio streams, images, video streams, photographs, graphical displays, text files, software applications, electronic messages, and the like.

In one embodiment, the methods and apparatuses for automatically controlling the sound level based on the content are configured to adjust the current sound level while utilizing the content based on preferences of the user. In one embodiment, the current sound level is adjusted multiple times based on the current location of the content. Further, the current sound level may be adjusted based on the content type such as music, television, commercials, and the like. In one embodiment, use of other devices also adjusts the current sound level of the content. For example, the detection of a telephone ringing or a telephone in use may decrease the current sound level of the content.

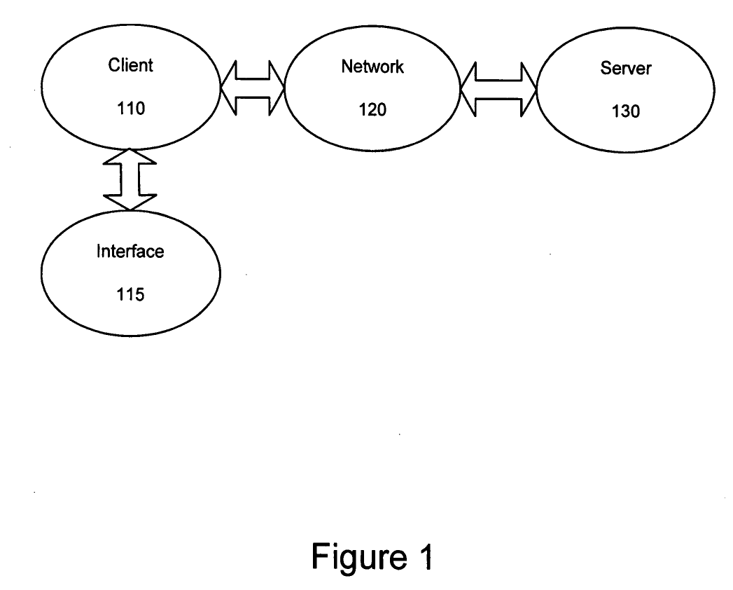

FIG. 1 is a diagram illustrating an environment within which the methods and apparatuses for automatically controlling the sound level based on the content are implemented. The environment includes an electronic device 110 (e.g., a computing platform configured to act as a client device, such as a personal digital video recorder, digital audio player, computer, a personal digital assistant, a cellular telephone, a camera device, a set top box, a gaming console), a user interface 115, a network 120 (e.g., a local area network, a home network, the Internet), and a server 130 (e.g., a computing platform configured to act as a server). In one embodiment, the network 120 can be implemented via wireless or wired solutions.

In one embodiment, one or more user interface 115 components are made integral with the electronic device 110 (e.g., keypad and video display screen input and output interfaces in the same housing as personal digital assistant electronics (e.g., as in a Clie® manufactured by Sony Corporation). In other embodiments, one or more user interface 115 components (e.g., a keyboard, a pointing device such as a mouse and trackball, a microphone, a speaker, a display, a camera) are physically separate from, and are conventionally coupled to, electronic device 110. The user utilizes interface 115 to access and control content and applications stored in electronic device 110, server 130, or a remote storage device (not shown) coupled via network 120.

In accordance with the invention, embodiments for automatically controlling the sound level based on the content as described below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

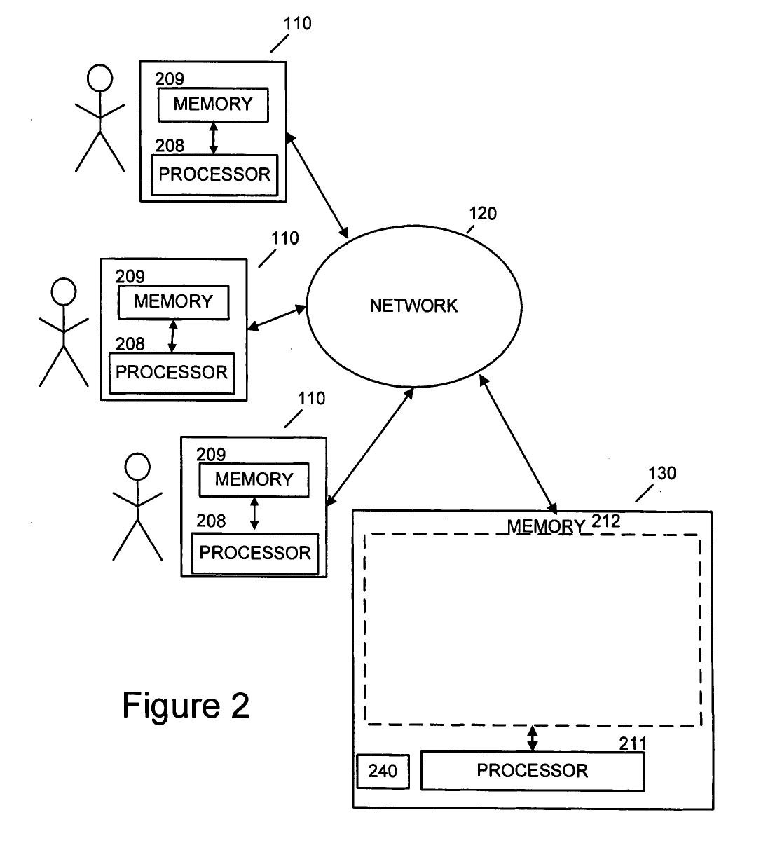

FIG. 2 is a simplified diagram illustrating an exemplary architecture in which the methods and apparatuses for automatically controlling the sound level based on the content are implemented. The exemplary architecture includes a plurality of electronic devices 110, a server device 130, and a network 120 connecting electronic devices 110 to server 130 and each electronic device 110 to each other. The plurality of electronic devices 110 are each configured to include a computer-readable medium 209, such as random access memory, coupled to an electronic processor 208. Processor 208 executes program instructions stored in the computer-readable medium 209. A unique user operates each electronic device 110 via an interface 115 as described with reference to FIG. 1.

Server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

The plurality of client devices 110 and the server 130 include instructions for a customized application for automatically controlling the sound level based on the content. In one embodiment, the plurality of computer-readable medium 209 and 212 contain, in part, the customized application. Additionally, the plurality of client devices 110 and the server 130 are configured to receive and transmit electronic messages for use with the customized application. Similarly, the network 120 is configured to transmit electronic messages for use with the customized application.

One or more user applications are stored in memories 209, in memory 211, or a single user application is stored in part in one memory 209 and in part in memory 211. In one instance, a stored user application, regardless of storage location, is made customizable based on automatically controlling the sound level based on the content as determined using embodiments described below.

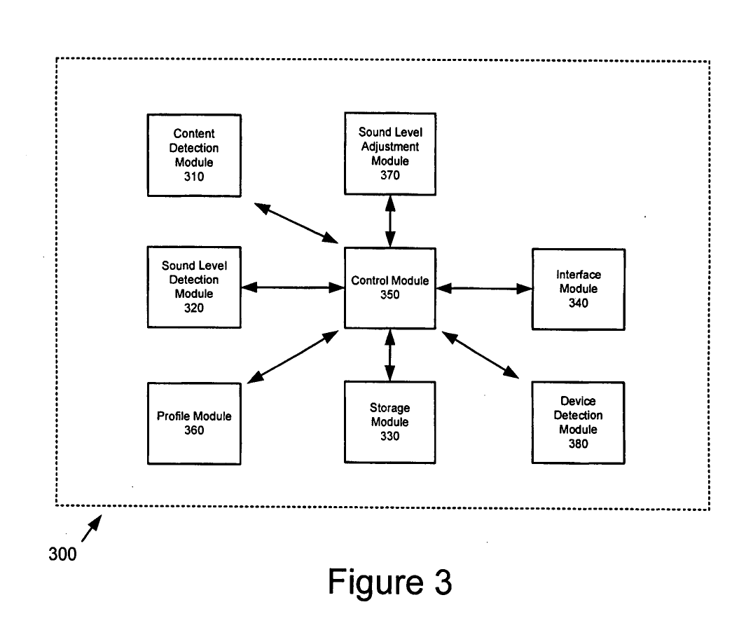

FIG. 3 illustrates one embodiment of a system 300 for automatically controlling the sound level based on the content. The system 300 includes a content detection module 310, a sound level detection module 320, a storage module 330, an interface module 340, a control module 350, a profile module 360, a sound level adjustment module 370, and a device detection module 380.

In one embodiment, the control module 350 communicates with the content detection module 310, the sound level detection module 320, the storage module 330, the interface module 340, the control module 350, the profile module 360, the sound level adjustment module 370, and the device detection module 380.

In one embodiment, the control module 350 coordinates tasks, requests, and communications between the content detection module 310, the sound level detection module 320, the storage module 330, the interface module 340, the control module 350, the profile module 360, the sound level adjustment module 370, and the device detection module 380.

In one embodiment, the content detection module 310 detects content such as images, text, graphics, video, audio, and the like. In one embodiment, the content detection module 310 is configured to uniquely identify the content.

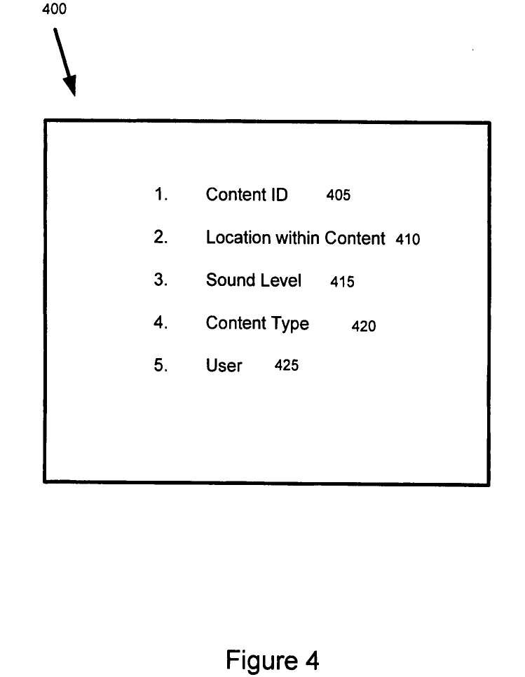

In addition to detecting the content, the content detection module 310 detects information related to the content. In one embodiment, information related to the content may include title of the content, content type, specific sound level of the content at specific locations, and the like. Further, information related to the content may be stored within profile information as shown in FIG. 4 or within metadata corresponding with the content.

In one embodiment, the sound level detection module 320 detects the sound level associated with the content. In one embodiment, the sound level detection module 320 detects a predetermined sound level for the specific content. In one embodiment, the predetermined sound level can be determined from the profile information associated with the content. In one embodiment, the predetermined sound level varies based on the portion of the content. In another embodiment, the predetermined sound level is constant throughout the content.

In another embodiment, the sound level detection module 320 detects changes to the sound level while the content is being played. For example, a user may manually change the sound level of the content while the content is being played in one embodiment. In some instances, the sound level may be changed multiple times throughout the content based on preferences of the user. In one embodiment, the sound level detection module 320 detects these changes in sound level and the location within the content that these changes occur.

In one embodiment, the storage module 330 stores a plurality of profiles wherein each profile is associated with various content and other data associated with the content. In one embodiment, the profile stores exemplary information as shown in a profile in FIG. 4. In one embodiment, the storage module 330 is located within the server device 130. In another embodiment, portions of the storage module 330 are located within the electronic device 110.

In one embodiment, the interface module 340 detects the electronic device 110 as the electronic device 110 is connected to the network 120.

In another embodiment, the interface module 340 detects input from the interface device 115 such as a keyboard, a mouse, a microphone, a still camera, a video camera, and the like.

In yet another embodiment, the interface module 340 provides output to the interface device 115 such as a display, speakers, external storage devices, an external network, and the like.

In one embodiment, the profile module 360 processes profile information related to the specific content. In one embodiment, exemplary profile information is shown within a record illustrated in FIG. 4. In one embodiment, each profile corresponds with a particular content. In another embodiment, groups of profiles correspond with a particular user.

In one embodiment, the sound level adjustment module 370 adjusts the sound level of the content detected within the content detection module 310.

In one embodiment, the sound level is adjusted by the sound level adjustment module 370 based on the current sound level detected by the sound level detection module. In another embodiment, the sound level is adjusted by the sound level adjustment module 370 based on the information stored within the profile module 360. In another embodiment, the sound level is adjusted by the sound level adjustment module 370 based on the devices detected within the device detection module 380.

In one embodiment, the device detection module 380 detects a presence of devices. In one embodiment, the devices include stationary devices such as video cassette recorders, DVD players, and televisions. In another embodiment, the devices also include portable devices such as laptop computers, cellular telephones, personal digital assistants, portable music players, and portable video players.

In one embodiment, the device detection module 380 detects each device for status. In one embodiment, status of the device includes whether the device is on, off, playing content, and the like. For example, the device detection module 380 is configured to detect whether a telephone is being utilized. In other examples, the telephone may be substituted for another device.

The system 300 in FIG. 3 is shown for exemplary purposes and is merely one embodiment of the methods and apparatuses for automatically controlling the sound level based on the content. Additional modules may be added to the system 300 without departing from the scope of the methods and apparatuses for automatically controlling the sound level based on the content. Similarly, modules may be combined or deleted without departing from the scope of the methods and apparatuses for automatically controlling the sound level based on the content.

FIG. 4 illustrates a simplified record 400 that corresponds to a profile that describes a specific content. In one embodiment, the record 400 is stored within the storage module 330 and utilized within the system 300. In one embodiment, the record 400 includes a content identification field 405, a location within content field 410, a sound level field 415, a content type field 420, and a user identification field 425.

In one embodiment, the content identification field 405 identifies a specific content associated with the record 400. In one example, the content's name is utilized as a label for the content identification field 405.

In one embodiment, the location within content field 410 is associated with a specific location within the content. In one embodiment, the specific location within the content may be identified by a time stamp.

In one embodiment, the sound level field 415 identifies the sound level that is desired for the content that is associated with the record 400. In one embodiment, a single sound level is assigned to the content. In another embodiment, different sound levels are assigned to different portions of the content as described by the location within content field 410.

In one embodiment, the content type field 420 identifies the type of content that is associated with the identified content with the record 400. In one embodiment, the types of content include music, television, commercials, talk radio, and the like. In another embodiment, within the music category, the types of content may be further distinguished by types of music such as rock, classical, jazz, heavy metal, and the like.

In one embodiment, the user identification field 425 identifies a user associated with the record 400. In one example, a user's name is utilized as a label for the user identification field 425.

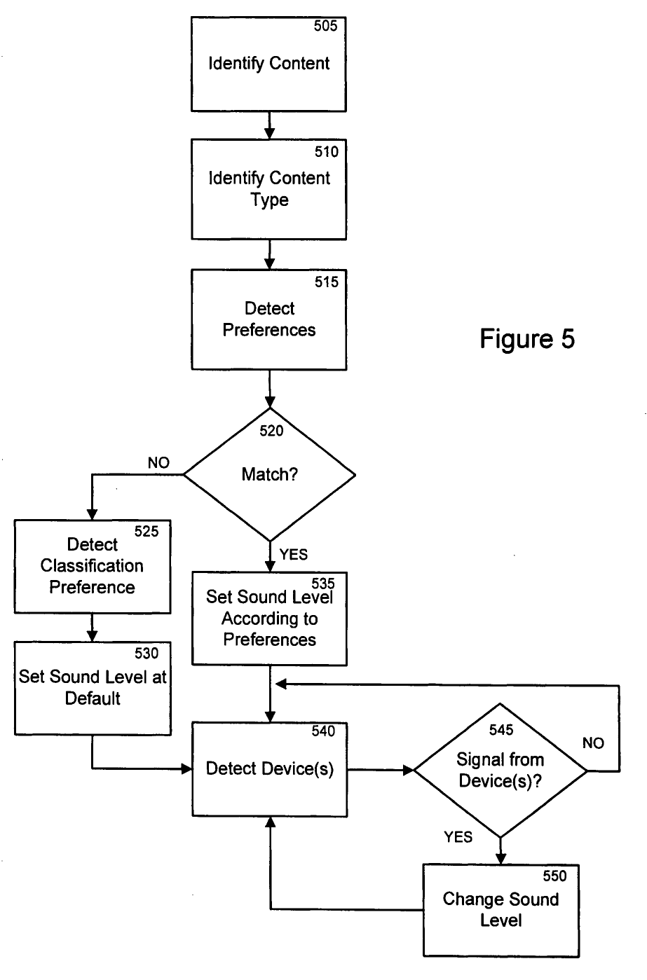

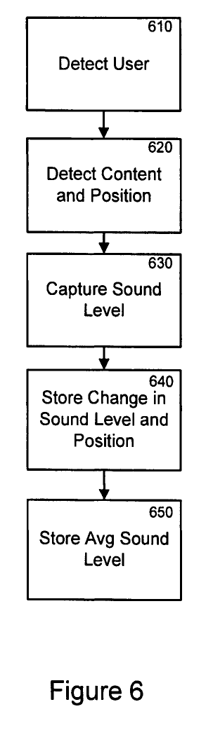

The flow diagrams as depicted in FIGS. 5 and 6 are one embodiment of the methods and apparatuses for automatically controlling the sound level based on the content. The blocks within the flow diagrams can be performed in a different sequence without departing from the spirit of the methods and apparatuses for automatically controlling the sound level based on the content. Further, blocks can be deleted, added, or combined without departing from the spirit of the methods and apparatuses for automatically controlling the sound level based on the content.

The flow diagram in FIG. 5 illustrates changing sound levels for content according to one embodiment of the invention.

In Block 505, content is identified. In one embodiment, specific content such as a television show that is being utilized is detected and identified.

In Block 510, content type associated with the identified content is also identified. In one embodiment, the types of content include music, television, commercials, talk radio, and the like. In another embodiment, within the music category, the types of content may be further distinguished by types of music such as rock, classical, jazz, heavy metal, and the like. In one embodiment, the detection of the content type is performed through detection of information associated with the identified content such as metadata, profile information, and the like.

In Block 515, preferences are detected that are associated with the identified content. In one embodiment, the preferences are stored within a profile as exemplified within record 400. In one embodiment, the preferences include sound level preferences for the entire content or portions of the content, association with particular users, and the content type of the content.

In Block 520, a match is performed between the identified content within the Block 505 and the preferences as detected within the Block 515.

If there is no match, then a classification preference is detected within Block 525. In one embodiment, the classification preference includes sound level preferences for a specific content type.

In Block 530, the sound level for the content is set at a default sound level. If the content type as detected within the Block 510 matches a sound level preference for the specific content type within the Block 530, then the content is played at the predetermined sound level preference. In another embodiment, if the content type is not sufficiently identified within the Block 510, then the identified content is played at a default sound level.

If there is a match within the Block 520, then the content is played at a predetermined sound level in Block 535. In one embodiment, each portion of the content is played at the predetermined sound level. For instance, if different portions of the content have different sound levels, then each portion of the content is played at the corresponding sound levels.

In another embodiment, each of the content types is associated with a unique sound level. Based on the content type detected within the Block 510, the identified content is played at the preferred sound level for the detected content type.

In Block 540, device(s) are detected. In one embodiment, one of the devices may include a telephone, a computer, a video device, and an audio device.

In Block 545, if a signal from the detected device is not detected, then devices are continually detected within the Block 540.

In Block 545, if a signal from the detected device is detected, then the sound level of the identified content is changed. In one embodiment, the signal may indicate an incoming telephone call through a ring indicator, a telephone connection, a telephone disconnection, initiating sound through a video device or audio device, and terminating sound through a video device or audio device.

In one embodiment, changing the sound level may either increase or decrease the new sound level relative to the prior sound level. For example, if the signal indicates a telephone connection, then the new sound level may be decreased relative to the prior sound level. Similarly, if the signal indicates a telephone disconnection, then the new sound level may be increased relative to the prior sound level.

The flow diagram in FIG. 6 illustrates capturing sound levels according to one embodiment of the invention.

In Block 610, a user is detected. In one embodiment, the identity of the user is detected through a logon process initiated by the user. In one embodiment, the user is associated with a profile as illustrated as an exemplary record 400 within FIG. 4.

In Block 620, content utilized by the detected user is also detected. In one embodiment, specific content such as a television show that is being viewed by the user is detected and identified. In another embodiment, the current location of the content being utilized is also identified. For example, the current location or time of the television show is identified and updated as the user watches the television show. Further, the television device utilized to view the television show is also detected.

In Block 630, the sound level of the content utilized is captured. In one embodiment, a change in the sound level is captured. Further, the location of the content is noted where the change in the sound level occurs. In one embodiment, the change in the sound level may be detected through a change in a volume control knob or other input.

In Block 640, the sound level is stored within a profile information that corresponds with the content and the user. In one embodiment, the location of the content is also stored with the corresponding sound level information.

In Block 650, an average sound level is stored for the identified content. In one embodiment, the average sound level is calculated as the average sound level over the course of playing the content. In one embodiment, the average sound level is stored for future use for this identified content. Further, the average sound level can also be utilized and averaged for the content type of the identified content.

In another embodiment, a most common sound level is stored for the identified content. In one embodiment, the most common sound level is the sound level that occurs for the greatest amount of time over the course of playing the content. In one embodiment, the most common sound level is stored for future use for this identified content. Further, the most common sound level can also be utilized and averaged for the content type of the identified content.

The foregoing descriptions of specific embodiments of the invention have been presented for purposes of illustration and description. For example, the invention is described within the context of dynamically detecting and generating image information as merely one embodiment of the invention. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed:

1. A method comprising:
detecting content and information related to the content;
utilizing the content at a current sound level; and
modifying the current sound level based on the information and the content.

2. The method according to claim 1 wherein the information is metadata describing the content.

3. The method according to claim 1 wherein the information includes a profile that includes one of a sound level for the content, a content type, and a location of the content.

4. The method according to claim 1 further comprising detecting a signal from a device.

5. The method according to claim 4 wherein the signal represents initiating on the device.

6. The method according to claim 4 wherein the signal represents terminating the device.

7. The method according to claim 4 further comprising adjusting the current sound level based on the signal.

8. The method according to claim 4 wherein the device is one of: a video player/recorder, an audio player, a gaming console, a set top box, a personal computer, a cellular telephone, and a personal digital assistant.

9. The method according to claim 1 further comprising storing the information within a profile.

10. The method according to claim 1 wherein the content is one of: an audio stream, an image, a video stream, a photograph, a graphical file, a text file, a software application, and an electronic message.

11. The method according to claim 1 further comprising detecting a change in the current sound level via a sound level control.

12. The method according to claim 11 further comprising storing the change in the current sound level as a portion of the information corresponding to the content.

13. The method according to claim 11 further comprising storing a location of the content when detecting the change in the current sound level.

14. The method according to claim 1 wherein modifying the current sound level is based on a content type of the content.

15. The method according to claim 14 wherein the content type includes one of: music, advertisements, television, movies, and conversations.

16. A system, comprising:
a content detection module configured for detecting content and information relating to the content;
a sound level detection module for detecting a current sound level of the content; and
a sound level adjustment module configured for adjusting the current sound level based on the information.

17. The system according to claim 16 wherein the information includes a profile that includes one of a sound level for the content, a content type, and a location of the content.

18. The system according to claim 16 wherein the information is metadata describing the content.

19. The system according to claim 16 wherein the content is one of: an audio stream, an image, a video stream, a photograph, a graphical file, a text file, a software application, and an electronic message.

20. The system according to claim 16 further comprising a profile module configured for tracking the content and the information.

21. The system according to claim 16 further comprising a storage module configured for storing the content and the information.

22. The system according to claim 16 further comprising a device detection module configured for detecting a device and a device signal.

23. The method according to claim 22 wherein the signal represents an initiation of the device.

24. The method according to claim 22 wherein the signal represents termination of the device.

25. The method according to claim 22 further comprising adjusting the current sound level based on the signal.

26. The method according to claim 22 wherein the device is one of: a video player/recorder, an audio player, a gaming console, a set top box, a personal computer, a cellular telephone, and a personal digital assistant.

27. A computer-readable medium having computer executable instructions for performing a method comprising:
detecting content and information related to the content;
utilizing the content at a current sound level; and
modifying the current sound level based on the information and the content.
